(19) United States
(12) Patent Application Publication
(10) Pub. No.: US 2009/0270211 A1
(43) Pub. Date: Oct. 29, 2009

(54) COAXIAL TRANSMISSSION AND TURNING STRUCTURE

(76) Inventor: Simon C. Chen, Taipei City (TW)

Correspondence Address: APEX JURIS, PLLC, 12733 LAKE CITY WAY NORTHEAST, SEATTLE, WA, 98125, US

(21) Appl. No.: 12/110,933

(22) Filed: Apr. 28, 2008

(51) Int. Cl. F16H 55/30

(52) U.S. Cl. 474/158

(57) ABSTRACT

The present invention discloses a coaxial transmission and turning structure, which uses dynamic force of a hand-held electric tool having an output head to drive a working platform. In the present invention, a fixed sleeve is joined to the working platform fixedly. A bearing sleeve is rotatably accommodated inside the fixed sleeve. A torsion rod is rotatably installed inside the bearing sleeve. A fixing brace is secured on the top of the bearing sleeve and used to hold the hand-held electric tool. Thereby, one end of the torsion rod is able to engage with the output head of the hand-held electric tool. The other end of the torsion rod uses a transmission mechanism installed in the other end of the bearing sleeve to drive a driving wheel installed in the bearing sleeve to rotate. Thereby, the present invention can drive the working platform to move.

### FIELD OF THE INVENTION

The present invention relates to a working platform, particularly to a transmission and turning mechanism for a working platform.

### BACKGROUND OF THE INVENTION

Refer to FIG. 1, wherein a conventional working platform 1 carries and elevates the personnel and machines to repair or refit a house. The conventional working platform 1 has wheels, and the personnel can pull or push the working platform 1 to move. However, the worker has to descend the working platform to push/pull the working platform 1 to move. Otherwise, there has to be another worker to push/pull the working platform 1.

The first way to move the working platform 1 makes the worker have to descend and ascend the working platform 1 many times, which should inconvenience the worker very much. The second way needs an additional worker, which raises the costs greatly.

### SUMMARY OF THE INVENTION

The primary objective of the present invention is to provide a transmission structure, whereby the personnel can independently operate the working platform to move without descending and ascending the working platform.

To achieve the above-mentioned objective, the present invention comprises: a fixed sleeve, a bearing sleeve, a fixing brace, a driving wheel, a transmission mechanism and a torsion rod. The fixed sleeve is joined to the working platform fixedly. The bearing sleeve is rotatably accommodated inside the fixed sleeve. The fixing brace is secured on the top of the bearing sleeve and used to hold a hand-held electric tool. The driving wheel is pivotally installed at the lower end of the bearing sleeve and has one degree of freedom to turn. The transmission mechanism is installed in the bearing sleeve and near the driving wheel; the transmission mechanism is engaged with the driving wheel and drives the driving wheel to rotate. The torsion rod is rotatably installed inside the bearing sleeve; two ends of the torsion rod are respectively engaged with an output head of the hand-held electric tool and the transmission mechanism.

Thereby, the torsion rod and the transmission mechanism transfer dynamic force of the hand-held electric tool to the driving wheel to drive the working platform to move. Further, the rotation of the bearing sleeve with respect to the fixed sleeve can turn the driving wheel to change the movement direction of the working platform.

### BRIEF DESCRIPTION OF THE DRAWINGS

FIG. 1 is a diagram schematically showing the structure of a conventional working platform.

FIG. 2 is a diagram schematically showing the structure of a coaxial transmission and turning structure according to the present invention.

FIG. 3 is a diagram schematically showing the structure of a transmission mechanism according to the present invention.

FIG. 4A is a sectional view schematically showing the engagement state of a clutch according to the present invention.

FIG. 4B is a sectional view schematically showing the detachment state of a clutch according to the present invention.

FIG. 4C is a sectional view schematically showing the engagement-ready state of a clutch according to the present invention.

FIG. 4D is a diagram schematically showing the positional relationship of a trench structure and a groove structure according to the present invention.

FIG. 5 is a diagram schematically showing another embodiment of the present invention to a working platform.

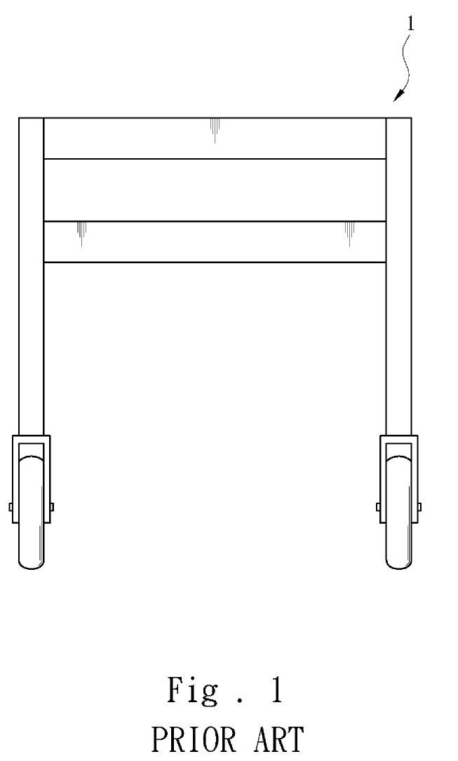

### DETAILED DESCRIPTION OF THE PREFERRED EMBODIMENTS

Below, the preferred embodiments are described in detail in cooperation with the drawings to exemplify the present invention.

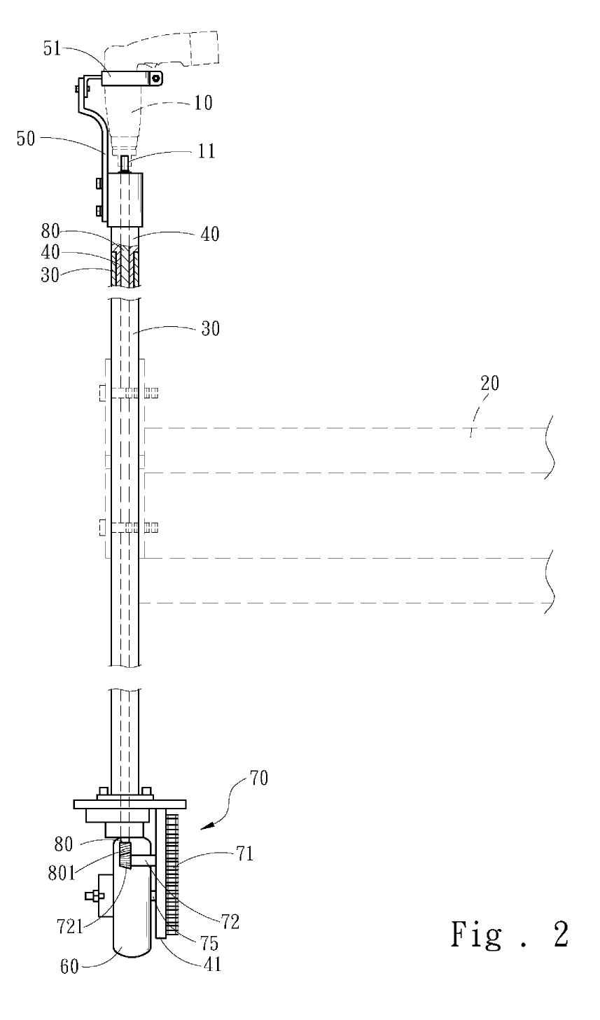

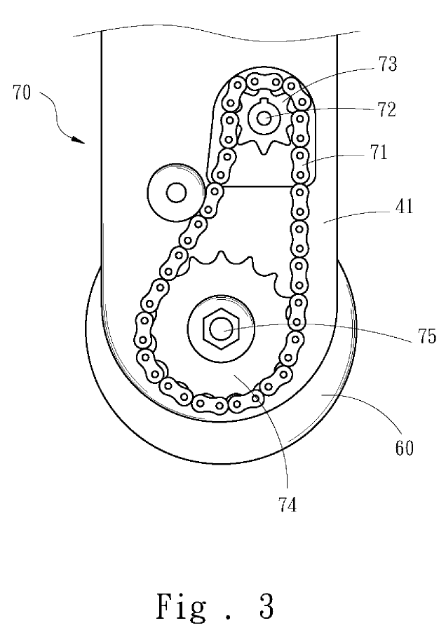

Refer to FIG. 2 and FIG. 3. The present invention proposes a coaxial transmission and turning structure, which uses dynamic force of a hand-held electric tool 10 having an output head 11 to drive a working platform 20. The transmission and turning structure of the present invention comprises: a fixed sleeve 30, a bearing sleeve 40, a fixing brace 50, a driving wheel 60, a transmission mechanism 70 and a torsion rod 80. The fixed sleeve 30 is joined to the working platform 20 fixedly. The bearing sleeve 40 is rotatably accommodated inside the fixed sleeve 30. The fixing brace 50 is secured on the top of the bearing sleeve 40 and used to hold the hand-held electric tool 10. The fixing brace 50 has a sleeve ring 51 used to sleeve and secure the hand-held electric tool 10.

A plate 41 is fixedly installed in the bearing sleeve 40, and the driving wheel 60 and the transmission mechanism 70 are installed in the plate 41. The driving wheel 60 is pivotally installed at the lower end of the bearing sleeve 40 and has one degree of freedom to turn. The transmission mechanism 70 is installed in the bearing sleeve 40 and near the driving wheel 60; the transmission mechanism 70 is engaged with the driving wheel 60 and drives the driving wheel 60 to rotate. The torsion rod 80 is rotatably installed inside the bearing sleeve 40; one end of the torsion rod 80 is to be engaged with the output head 11 of the hand-held electric tool 10, and the other end of the torsion rod 80 is engaged with the transmission mechanism 70.

The transmission mechanism 70 further comprises: a chain 71, a first spindle 72, a first gear 73, a second gear 74, and a second spindle 75. The first and second spindles 72 and 75 penetrate the plate 41 and respectively connect with the first and second gears 73 and 74 at the same side of the plate 41. The chain 71 engages with the first and second gears 73 and 74. On the other side of the plate 41, the first spindle 72 is joined to a sector gear 721, and the torsion rod 80 has a worm gear 801 engaged with the sector gear 721. On the same side of the sector gear 721, the second spindle 75 is joined to the driving wheel 60.

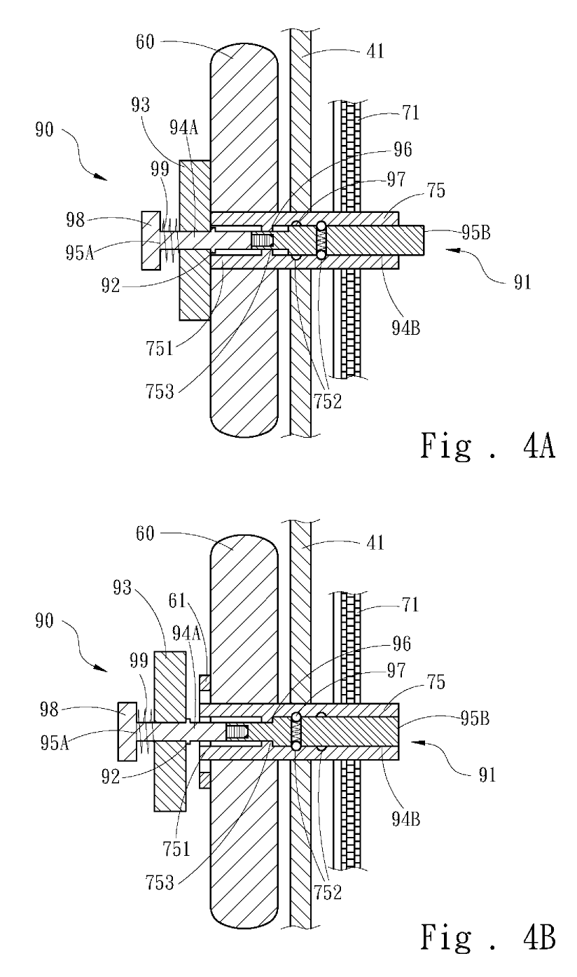

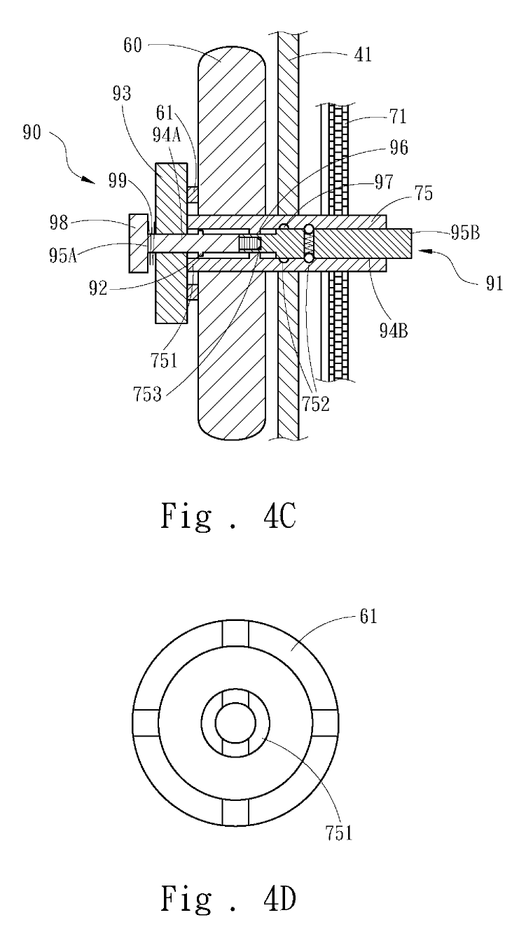

Refer from FIG. 4A to FIG. 4D. A clutch 90, which is able to detach the driving wheel 60 from the second spindle 75, is installed between the driving wheel 60 and the second spindle 75. Via the clutch 90, a user can alternatively push the working platform 20 to move by human power. The driving wheel 60 has a simultaneous trench structure 61, and the second spindle 75 has a simultaneous groove structure 751 corresponding to the trench structure 61. A slide rod 91, which is slidable in the axial direction, is arranged inside the second spindle 75. A fitting ring 92 is formed on the slide rod 91, and an insert block 93 is installed in the fitting ring 92. The insert block 93 can be press-fitted into the aligned trench structure 61 and groove structure 751 simultaneously, whereby the dynamic force of the second spindle 75 can be transferred to the driving wheel 60. When the insert block 93 is detached from the trench structure 61 and groove structure 751, the second spindle 75 will rotate freely with respect to the driving wheel 60.

Two long rods 94A and 94B are joined together to form the slide rod 91 and respectively have press ends 95A and 95B. The slide rod 91 has a discontinuous section 96 and a press-fit protrusion 97. Inside the second spindle 75, two press-fit slots 752 are respectively arranged at different positions and able to accommodate the press-fit protrusion 97. Inside the second spindle 75, there is a limit wall 753. The limit wall 753 blocks the discontinuous section 96 and limits the slide travel of the slide rod 91 when the press end 95B is pressed. Whether the insert block 93 is press-fitted into the trench structure 61 and groove structure 75 simultaneously is determined by the position of the slide rod 91, and the position of the slide rod 91 is determined by which press-fit slot 752 the press-fit protrusion 97 is press-fitted into.

The slide rod 91 has a protrusion ring 98 outside the insert block 93, and a spring 99 is arranged between the protrusion ring 98 and the insert block 93. The insert block 93 can slide with respect to the slide rod 91 and toward the protrusion ring 98 and compress the spring 99 at the same time. When the groove structure 751 has not been aligned to the trench structure 61, the protrusion ring 98 is pressed to move the press end 95A and makes the press-fit protrusion 97 of the slide rod 91 be press-fitted into the press-fit slot 752. Thereby, the spring 99 is compressed to apply force to the insert block 93. Thus, when the groove structure 751 rotates to a position where the groove structure 751 is aligned to the trench structure 61, the insert block 93 will be pressed into the trench structure 61 and groove structure 751 simultaneously by the spring 99.

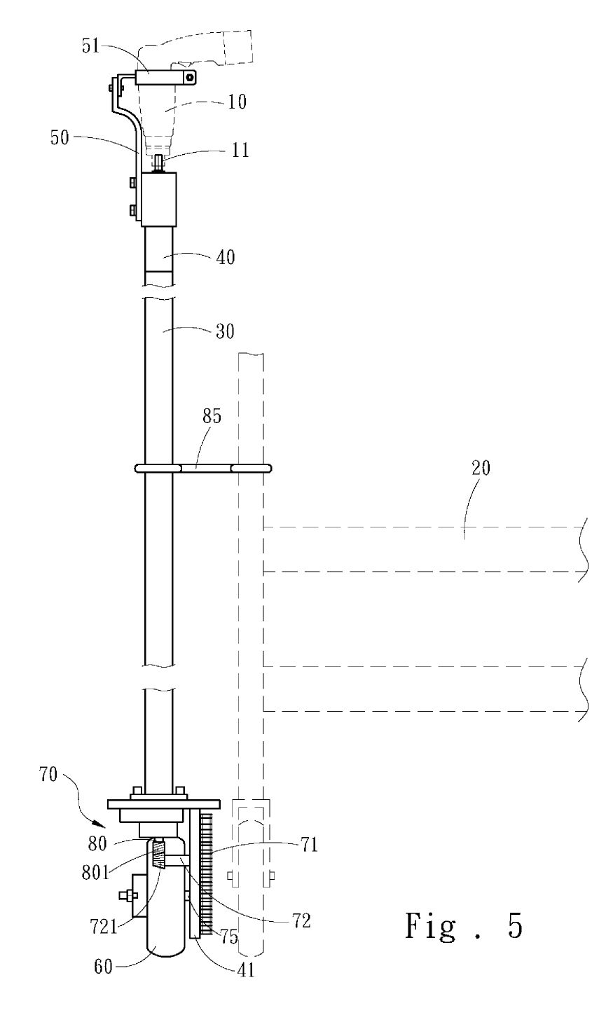

Refer to FIG. 5. The fixed sleeve 30 may function as one of the support wheels of the working platform 20, as shown in FIG. 2. Alternatively, the working platform 20 has its own support structures, and the fixed sleeve 30 is fastened to the working platform 20 via a fixing clip 85.

In the structure disclosed in the present invention, the working platform 20 has rollable wheels with the degree of freedom to turn; the dynamic force of the hand-held electric tool 10 is transferred by the torsion rod 80 and the transmission mechanism 70 to drive the driving wheel 60 to rotate. The rotation of the bearing sleeve 40 with respect to the fixed sleeve 30 can swivel the driving wheel 60 to turn while the driving wheel 60 is driving the working platform 20 to move. Thus, a user can control the direction and distance of the working platform's movement by only using the driving wheel 60 without using additional power. In the present invention, one of the wheels of the working platform 20 (not the driving wheel 60) may have a snap-fit switch. The locking and releasing of the snap-fit switch can determine whether the wheel has a degree of freedom to turn and thus can control the movement direction of the working platform 20.

As described above, the personnel on the working platform 20 can use the present invention to arbitrarily move the working platform 20 to the intended position without the help of other people and without descending and ascending the working platform 20.

What is claimed is:

1. A coaxial transmission and turning structure, which uses dynamic force of a hand-held electric tool having an output head to drive a working platform, comprising:
a fixed sleeve, joined to said working platform fixedly;
a bearing sleeve, rotatably accommodated inside said fixed sleeve;
a fixing brace, secured on the top of said bearing sleeve and used to hold said hand-held electric tool;
a driving wheel, pivotally installed at the lower end of said bearing sleeve and has one degree of freedom to turn;
a transmission mechanism, installed in said bearing sleeve and near said driving wheel, engaged with said driving wheel and driving said driving wheel to rotate; and
a torsion rod, rotatably installed inside said bearing sleeve with one end thereof engaged with said output head of said hand-held electric tool and the other end thereof engaged with said transmission mechanism.

2. The coaxial transmission and turning structure according to claim 1, wherein said fixing brace has a sleeve ring used to sleeve and secure said hand-held electric tool.

3. The coaxial transmission and turning structure according to claim 1, wherein a plate is fixedly installed in said bearing sleeve, and said driving wheel and said transmission mechanism are installed in said plate.

4. The coaxial transmission and turning structure according to claim 3, wherein said transmission mechanism further comprises: a chain, a first spindle, a first gear, a second gear, and a second spindle; said first spindle and said second spindle penetrate said plate and respectively connect with said first gear and said second gear at the same side of said plate; said chain engages with said first gear and said second gear; on the other side of the plate, said first spindle has a sector gear, and said torsion rod has a worm gear engaged with said sector gear; on the same side where said sector gear is located, said second spindle is joined to said driving wheel.

5. The coaxial transmission and turning structure according to claim 4, wherein a clutch is installed between said second spindle and said driving wheel.

6. The coaxial transmission and turning structure according to claim 5, wherein said clutch is constructed as follows: said driving wheel has a simultaneous trench structure, and said second spindle has a simultaneous groove structure corresponding to said trench structure; a slide rod, which is slidable in the axial direction, is arranged inside said second spindle; a fitting ring is formed on said slide rod, and an insert block is installed in said fitting ring; said insert block is able to be press-fitted into aligned said trench structure and said groove structure simultaneously, and dynamic force of said second spindle is thus transferred to said driving wheel.

7. The coaxial transmission and turning structure according to claim 6, wherein two long rods are joined together to form said slide rod and respectively have press ends; said slide rod has a discontinuous section and a press-fit protrusion; inside said second spindle, two press-fit slots are respectively arranged at different positions and able to accommodate said press-fit protrusion; inside said second spindle, there is a limit wall; said limit wall blocks said discontinuous section and limits the slide travel of said slide rod when said press end is pressed; whether said insert block is press-fitted into said trench structure and said groove structure simultaneously is determined by the position of said slide rod, and the position of said slide rod is determined by which one of said press-fit slots said press-fit protrusion is press-fitted into.

8. The coaxial transmission and turning structure according to claim 7, wherein said slide rod has a protrusion ring outside said insert block, and a spring is arranged between said protrusion ring and said insert block; said insert block is able to slide with respect to said slide rod and toward said protrusion ring and compresses said spring at the same time.

9. The coaxial transmission and turning structure according to claim 1, wherein said fixed sleeve is fastened to said working platform via a fixing clip.
